(19) United States
(12) Patent Application Publication
(10) Pub. No.: US 2006/0012669 A1
(43) Pub. Date: Jan. 19, 2006

(54) Laser scanning optical unit used in image forming apparatus

(75) Inventors: Hajime Taniguchi, Toyokawa-shi (JP); Kenji Takeshita, Toyokawa-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/017,636

(22) Filed: Dec. 22, 2004

(30) Foreign Application Priority Data
Jul. 15, 2004 (JP) 2004-208723

(51) Int. Cl. B41J 15/14

(52) U.S. Cl. 347/243

(57) ABSTRACT

A image forming apparatus includes a plurality of photoreceptors and laser scanning optical units corresponding to the photoreceptors. Each of laser scanning optical units includes a laser light source, a deflector disposed so as to be rotatable about an axis parallel to the conveyance direction of a transfer belt, a first mirror that reflects a laser beam deflected for scanning by the deflector in a direction opposite to the direction of disposition of the photoreceptor, in a direction parallel to the conveyance direction of the transfer belt and a second mirror that reflects the laser beam reflected by the first mirror, toward the photoreceptor.

This application is based on Japanese Patent Application(s) No(s). 2004-208723 filed in Japan on Jul. 15, 2004, the entire content of which is hereby incorporated by reference.

### BACKGROUND OF THE INVENTION

1. Field of the Invention

The present invention relates to a laser scanning optical unit, particularly, to a laser scanning optical unit disposed so as to correspond to each photoreceptor in a tandem electrophotographic image forming apparatus having a plurality of photoreceptors disposed in parallel.

2. Description of Related Art

Generally, as systems that form color images by electrophotography, various tandem systems have been proposed in which four photoreceptor drums are disposed in parallel on the route of movement of the transfer belt, images of the three primary colors (magenta, yellow and cyan) and black are formed on the photoreceptor drums, respectively, and the images are superimposed one on another on the sheet.

Moreover, these tandem systems employ a configuration in which a laser scanning optical unit is disposed so as to correspond to each of the photoreceptor drums to simplify the laser scanning optical unit.

When a laser scanning optical unit is provided so as to correspond to each photoreceptor drum, in tandem image forming apparatuses of this type, to avoid an increase in the size of the apparatus itself, it is required that the laser scanning optical units be compact, particularly, the disposition pitch of the photoreceptor drums be minimized.

Conventionally used laser scanning optical units of this type are broadly divided into three kinds which are shown in FIGS. 5, 6 and 7, respectively.

In the laser scanning optical unit shown in FIG. 5, a laser beam LB deflected for scanning by a deflector 3 passes through a first scanning lens 6, is bent 90 degrees downward by a mirror 7, and then, passes through a second scanning lens 8 to be directed to a photoreceptor drum 9. In this case, the disposition pitch P of the photoreceptor drum 9 is restricted by the dimension A of the laser scanning optical unit. The dimension A which is subject to constraints such as the two-dimensional size of the deflector 3, the axial thickness of the first scanning lens 6 and the width of the mirror 7 is comparatively large, so that it is difficult to reduce the pitch P.

In the laser scanning optical unit shown in FIG. 6, the laser beam LB deflected for scanning by the deflector 3 is bent by mirrors 7a and 7b, passes through the first scanning lens 6, is bent downward by a mirror 7c and then, passes through the second scanning lens 8 to be directed to the photoreceptor drum 9. Like the optical unit shown in FIG. 5, this optical unit is disadvantageous in reducing the size of the tandem image forming apparatus because the disposition pitch P of the photoreceptor drum 9 is restricted by the dimension A of the optical unit.

In the laser scanning optical unit shown in FIG. 7, the laser beam LB deflected for scanning by the deflector 3 is directed to the photoreceptor drum 9 while passing through the first and second scanning lenses 6 and 8 without the intervention of a mirror. This optical unit has an advantage that it can be comparatively thin because it is necessary for the dimension A only to be equal to the thickness of the deflector 3 and the scanning lenses 6 and 8. However, since the optical path is not bent, the optical path length becomes the length B of the optical unit as it is, and this rather increases the image forming apparatus in size.

### OBJECT AND SUMMARY

Accordingly, an object of the present invention is to provide a compact laser scanning optical unit in which the disposition pitch of a plurality of photoreceptors can be small and that is optimum for tandem image forming apparatuses.

To solve the above-mentioned object, a first aspect of the invention is a laser scanning optical unit provided so as to correspond to each of a plurality of photoreceptors disposed in parallel. The laser scanning optical unit is provided with a laser light source, a deflector, a scanning optical element, a reflecting mirror, and a housing containing these members. The laser beam incident on the deflector is deflected for scanning in a direction opposite to the direction of disposition of the photoreceptor, and the optical path along which the laser beam deflected for scanning by the deflector and having passed through the scanning optical element is directed to the photoreceptor while being bent by the reflecting mirror disposed in the last stage is set so as to be substantially orthogonal to the rotation axis of the deflector and pass through a space between two planes that define the outermost part of the housing to reach the photoreceptor.

Moreover, a second aspect of the invention is a laser scanning optical unit provided with the same elements as those of the first aspect of the invention. The optical path along which the laser beam deflected for scanning by the deflector and having passed through the scanning optical element is directed to the photoreceptor while being bent by the reflecting mirror disposed in the last stage is set so as to pass a plane substantially orthogonal to the rotation axis of the deflector within the outer range of the housing to reach the photoreceptor.

In the laser scanning optical units according to the first and second aspects of the invention, since the laser beam bent by the reflecting mirror disposed in the last stage is set so as to be substantially orthogonal to the rotation axis of the deflector and pass through the space between the two planes that define the outermost part of the housing to reach the photoreceptor, or since the optical path is set so as to pass a plane substantially orthogonal to the rotation axis of the deflector within the outer range of the housing to reach the photoreceptor, the width of the optical unit is small, so that the tandem image forming apparatus can be reduced in size by reducing the disposition pitch of the photoreceptor drums. Further, since the laser beam incident on the deflector is deflected for scanning in a direction opposite to the direction of disposition of the photoreceptor and the optical path is appropriately bent, the distance between the photoreceptor and the optical unit can be reduced.

Moreover, an image forming apparatus according to a third aspect of the invention is an image forming apparatus provided with: a plurality of photoreceptors disposed along a rotatable transfer belt; and a plurality of laser scanning optical units provided for the photoreceptors, respectively. Each of the laser scanning optical units is provided with: a laser light source; a deflector disposed so as to be rotatable about an axis parallel to the conveyance direction of the transfer belt; a first mirror that reflects a laser beam deflected for scanning by the deflector in a direction opposite to the direction of disposition of the photoreceptor, in a direction parallel to the conveyance direction of the transfer belt; and a second mirror that reflects the laser beam reflected by the first mirror, toward the photoreceptor.

The deflector may include a polygon mirror and a motor that rotates the polygon mirror so that the laser beam reflected by the second mirror passes through a space on the side opposite to the polygon mirror with respect to the motor.

Moreover, an optical system may be disposed between the first mirror and the second mirror.

Further, as the plurality of laser scanning optical units, laser scanning optical units of the same structure may be disposed in the same positional relationship with respect to the photoreceptors.

### BRIEF DESCRIPTION OF THE DRAWINGS

These and other objects and features of the invention will become clear from the following description taken in conjunction with the preferred embodiments thereof with reference to the accompanying drawings, in which:

FIG. 1 is a schematic block diagram showing a laser scanning optical unit according to a first embodiment of the present invention;

FIG. 2 is a perspective view showing a relevant part of the laser scanning optical unit;

FIG. 3 is a schematic block diagram showing a relevant part of a tandem electrophotographic image forming apparatus provided with the laser scanning optical unit;

FIG. 4 is a schematic block diagram showing a laser scanning optical unit according to a second embodiment of the present invention;

FIG. 5 is a schematic block diagram showing the first example of the conventional laser scanning optical unit;

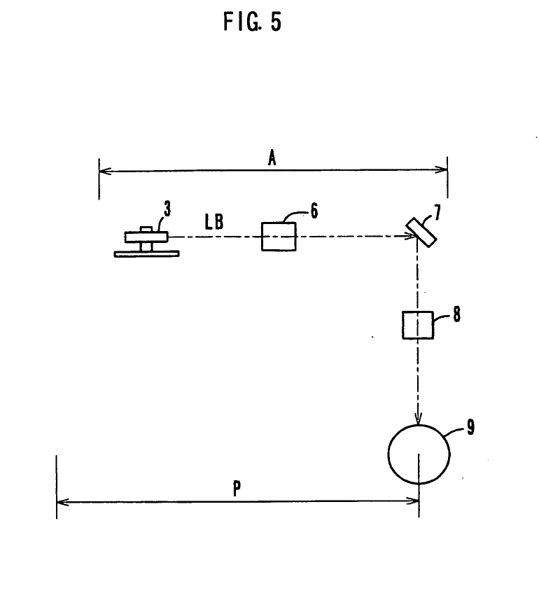

FIG. 6 is a schematic block diagram showing the second example of the conventional laser scanning optical unit; and

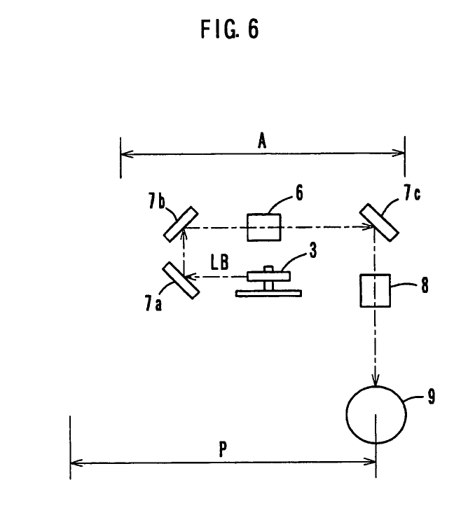

FIG. 7 is a schematic block diagram showing the third example of the conventional laser scanning optical unit.

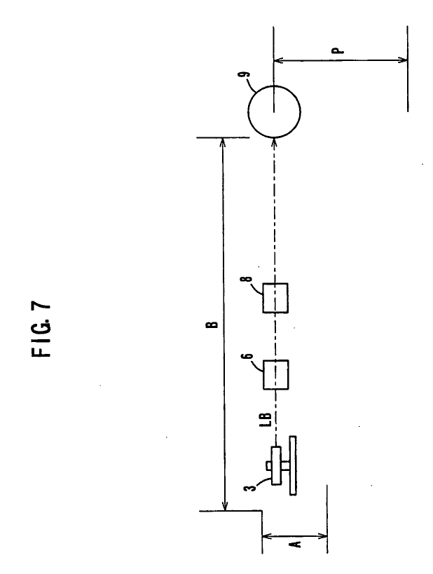

### DETAILED DESCRIPTION OF THE PREFERRED EMBODIMENTS

Hereinafter, embodiments of the laser scanning optical unit according to the present invention will be described with reference to the attached drawings.

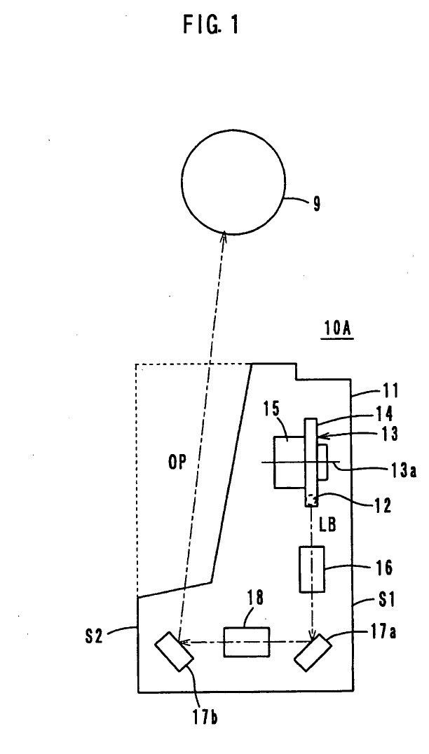

(First embodiment, see FIGS. 1 to 3)

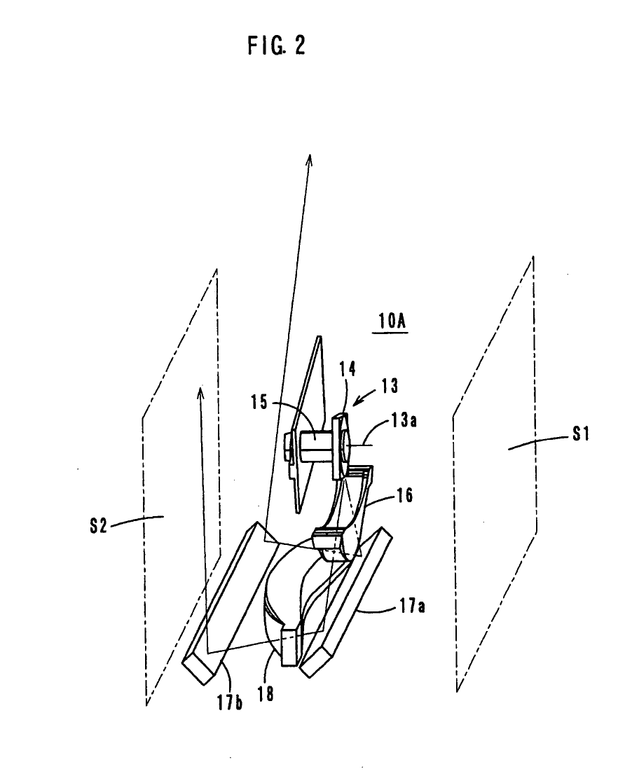

In FIGS. 1 and 2, a laser scanning optical unit 10A comprises a housing 11 in which a light source 12, a deflector 13, a first scanning lens 16, a reflecting mirror 17a, a second scanning lens 18 and a reflecting mirror 17b are provided, and a laser beam is emitted to a photoreceptor drum 9 to form an image (electrostatic latent image).

The deflector 13 is structured so that a polygon mirror 14 provided with four reflecting and deflecting surfaces is rotated about a rotation axis 13b thereof at constant speed by a motor 15. The laser beam emitted from the light source 12 is incident on the reflecting and deflecting surface of the polygon mirror 14 from a direction perpendicular to the plane of FIG. 1, and the laser beam LB is deflected for scanning in a direction opposite to the direction of disposition of the photoreceptor drums 9.

The laser beam LB deflected for scanning by the deflector 13 passes through the first scanning lens 16, is bent 90 degrees by the reflecting mirror 17a, passes through the second scanning lens 18, and is then bent upward by the reflecting mirror 17b to be directed to the photoreceptor drum 9.

The optical path OP bent by the reflecting mirror 17b disposed in the last stage to be directed to the photoreceptor drum 9 is set so as to be substantially orthogonal to the rotation axis 13a of the deflector 13 and pass through a space between planes S1 and S2 that define the outermost part of the housing 11 to reach the photoreceptor 9.

In other words, the optical path OP directed to the photoreceptor drum 9 while being bent by the reflecting mirror 17b disposed in the last stage is set so as to pass planes substantially orthogonal to the rotation axis 13a of the deflector 13 within the outer range of the housing 11 to reach the photoreceptor drum 9. Here, the outer range of the housing 11 means a range including the substantially occupied space when it is assumed that the housing 11 is a rectangular parallelepiped (the range including the space shown by the dotted line in FIG. 1).

In the first embodiment, the optical path OP runs on the rear surface side (the side where the motor 15 is placed) of the deflector 13.

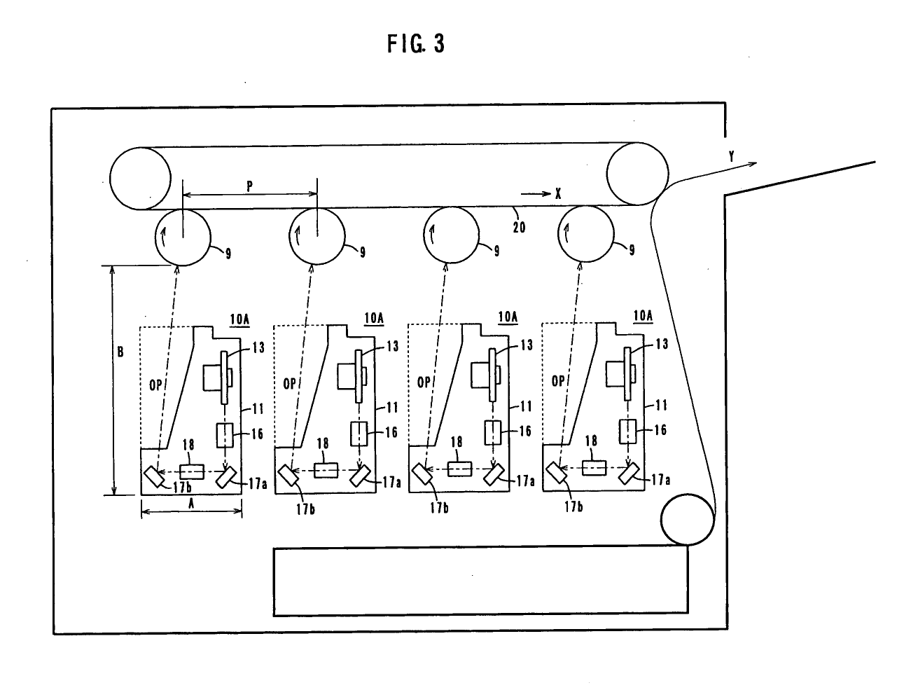

FIG. 3 shows a condition where the above-described laser scanning optical unit 10A is incorporated in a tandem electrophotographic image forming apparatus. The laser scanning optical unit 10A is disposed below the photoreceptor drums 9 so as to correspond to each of the four photoreceptor drums 9 disposed in parallel. These laser scanning optical units 10A are all the same, and are set in the same positional relationship with respect to the photoreceptors.

Immediately above the photoreceptor drums 9, a transfer belt 20 is set so as to be rotatable in the direction of the arrow X. In this image forming apparatus, the axes of the polygon mirrors 14 are parallel to the conveyance direction of the transfer belt, and the laser beam reflected by the reflecting mirror 17a is parallel to the conveyance direction of the transfer belt. In this embodiment, the axes of the polygon mirrors 12 are horizontally disposed.

While non-illustrated units such as a charging unit, a developer unit and a transferring unit are disposed around each photoreceptor drum 9, since the structures and workings of these members are known, descriptions thereof are omitted.

Images (electrostatic latent images) of magenta, yellow, cyan and black are formed on the photoreceptor drums 9 by the laser beams emitted from the optical units 10A, and after toner is attached thereto, the images are successively superimposed on the transfer belt 20 to be primarily transferred, thereby forming a color image. The formed color image is secondarily transferred onto the sheet conveyed along the path shown by the arrow Y.

In the laser scanning optical unit 10A having the above-described structure, since the optical path OP is set so that the laser beam bent by the reflecting mirror 17b disposed in the last stage passes the planes substantially orthogonal to the rotation axis 13a of the deflector 13 within the outer range of the housing 11 to reach the photoreceptor drum 9, the width A of the optical unit 10A is small, so that the tandem image forming apparatus can be reduced in size by reducing the disposition pitch P of the photoreceptor drums 9.

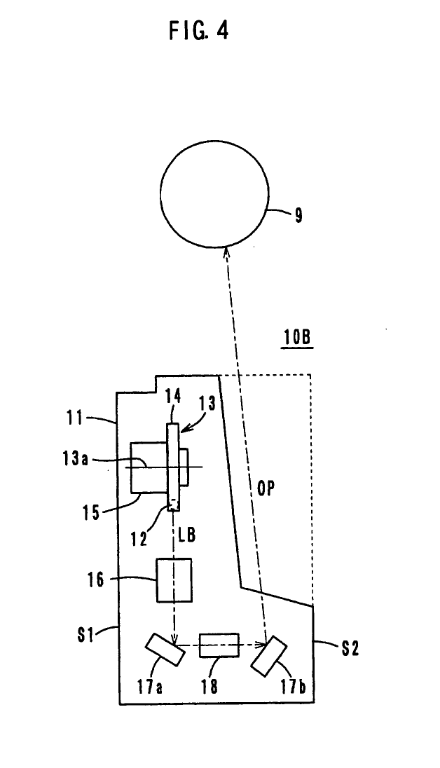

Further, since the laser beam incident on the deflector 13 is deflected for scanning in a direction opposite to the direction of disposition of the photoreceptor drums 9 and the optical path is appropriately bent, the distance between the photoreceptors 9 and the optical units 10A, that is, the distance B from the photoreceptor drums 9 to an end of the housings 11 can be reduced.

<Second embodiment, see FIG. 4)

A laser scanning optical unit 10B according to this second embodiment basically has a similar structure to that of the first embodiment. The laser scanning optical unit 10B is different in that the optical path OP of the laser beam bent by the reflecting mirror 17b is set so as to run on the side, opposite to the side of the motor 15, of the deflector 13. The condition where the laser scanning optical unit 10B is incorporated in a tandem image forming apparatus can be understood by referring to FIG. 3. Therefore, the workings and effects of the second embodiment are similar to those of the first embodiment.

Except this, the structure is similar to that of the first embodiment. Therefore, in FIG. 4, the same members as those of FIG. 1 are denoted by the same reference numerals and overlapping descriptions are omitted.

Although the present invention has been fully described in connection with the preferred embodiments thereof with reference to the accompanying drawings, it is to be noted that various changes and modifications are apparent to those skilled in the art. Such changes and modifications are to be understood as included with in the scope of the present invention as defined by the appended claims unless they depart therefrom.

The laser scanning optical unit according to the present invention is not limited to the above-described embodiments and may be modified in various manners without departing from the gist thereof.

In particular, details of the structure of the housing 11 and the structure and positional relationship of the scanning lenses 16 and 18 are arbitrary. Moreover, in the tandem structure shown in FIG. 3, the positional relationship between the photoreceptor drums 9 and the optical units 10A may be such that the optical units 10A are disposed above the photoreceptor drums 9.

What is claimed is:

1. A laser scanning optical unit provided so as to correspond to each of a plurality of photoreceptors disposed in parallel and including a laser light source for irradiating laser beam, a deflector, a scanning optical element, a reflecting mirror and a housing containing these members, wherein said laser beam incident on the deflector is deflected for scanning in a direction opposite to the direction of disposition of the photoreceptor, and the optical path along which the laser beam deflected for scanning by the deflector and having passed through the scanning optical element is directed to the photoreceptor while being bent by the reflecting mirror disposed in the last stage is set so as to be substantially orthogonal to the rotation axis of the deflector and pass through a space between two planes that define the outermost part of the housing to reach the photoreceptor.

2. A laser scanning optical unit as claimed in claim 2, wherein said rotation axis of the deflector is horizontally disposed.

3. A laser scanning optical unit provided so as to correspond to each of a plurality of photoreceptors disposed in parallel and including a laser light source for irradiating laser beam, a deflector, a scanning optical element, a reflecting mirror and a housing containing these members, wherein said laser beam incident on the deflector is deflected for scanning in a direction opposite to the direction of disposition of the photoreceptor, and the optical path along which the laser beam deflected for scanning by the deflector and having passed through the scanning optical element is directed to the photoreceptor while being bent by the reflecting mirror disposed in the last stage is set so as to pass a plane substantially orthogonal to the rotation axis of the deflector within the outer range of the housing to reach the photoreceptor.

4. A laser scanning optical unit as claimed in claim 3, wherein said rotation axis of the deflector is horizontally disposed.

5. An image forming apparatus including a rotatable transfer belt, a plurality of photoreceptors disposed along the rotatable transfer belt and a plurality of laser scanning optical units provided for the photoreceptors, respectively, each of said laser scanning optical units comprising:
a laser light source;
a deflector disposed so as to be rotatable about an axis parallel to the conveyance direction of the transfer belt;
a first mirror that reflects a laser beam deflected for scanning by the deflector in a direction opposite to the direction of disposition of the photoreceptor, in a direction parallel to the conveyance direction of the transfer belt; and
a second mirror that reflects the laser beam reflected by the first mirror, toward the photoreceptor.

6. An image forming apparatus as claimed in claim 5, wherein the optical path along which the laser beam reflected by the second mirror is directed to the photoreceptor is set so as to pass a plane substantially orthogonal to the rotation axis of the deflector.

7. An image forming apparatus as claimed in claim 5, wherein said deflector includes a polygon mirror and a motor for rotating the polygon mirror so that the laser beam reflected by the second mirror passes through a space on the side opposite to the polygon mirror with respect to the motor.

8. An image forming apparatus as claimed in claim 5, wherein each of said laser scanning optical units further comprises an optical element disposed between the first mirror and the second mirror.

9. An image forming apparatus as claimed in claim 5, the laser scanning optical units are disposed in the same positional relationship with respect to the photoreceptors.

10. An image forming apparatus as claimed in claim 5, wherein said laser scanning optical units are disposed below the photoreceptors.
